(19) United States
(12) Patent Application Publication
(10) Pub. No.: US 2005/0106338 A1
(43) Pub. Date: May 19, 2005

(54) Electron-beam cured heat-transfer label

(76) Inventor: Wallace J. Maynard, Wrightstown, WI (US)

Correspondence Address: Philip M. Weiss;Weiss & Weiss, 310 Old Country Road, Garden City, NY, 11530, US

(21) Appl. No.: 10/712,722

(22) Filed: Nov. 13, 2003

(51) Int. Cl. B41M 5/40

(52) U.S. Cl. 428/32.81

(57) ABSTRACT

A heat transfer label with an electron beam cured surface, and a method for producing the same.

### FIELD OF THE INVENTION

The present invention relates to a low-cost heat transfer label with an electron beam cured surface (to replace polyethylene or similar layers), and to a method for producing the same.

### BACKGROUND OF THE INVENTION

The present invention relates to heat-transfer label assemblies. Heat-transfer labels are devices commonly used to decorate and/or to label commercial plastic and glass articles such as beverage containers (including but not limited to alcoholic beverages like beer), detergents, health and beauty products, essential oils, chemicals and cleaning solutions, as well as other commercial products and products sold in a retail environment. Heat-transfer labels have high quality graphics and need to be resistant to abrasion and chemical effects in order to avoid erasure of label information. They also must possess good adhesion to the articles to which they are affixed. Heat-transfer labels are typically constructed as part of a heat-transfer label assembly, with one or more heat-transfer labels printed on a removable carrier web.

Traditional heat-transfer label assemblies are described in U.S. Pat. No. 3,616,015, which discloses a heat-transfer label assembly comprising a paper sheet or web, a wax release layer affixed to the paper sheet, and an ink design layer printed on the wax release layer. In the heat-transfer labeling process, the label-carrying web is subjected to heat, and the label is pressed onto the article with an ink design layer making direct contact with the article being labeled. As the paper sheet is heated, the wax layer begins to melt, enabling the paper sheet to be released from the ink design layer. A portion of the wax layer is transferred with the ink design onto the article, while a portion also remains with the paper sheet. After transfer of the ink design to the article, the paper sheet is removed leaving the printed design affixed to the article and the transferred wax layer exposed to the environment on the outside of the affixed label. The wax layer has two purposes: (1) to provide a release layer for transfer of the ink/printed design from the web when heat is applied to the paper web; and (2) to provide a protective layer over the transferred printed/ink design comprising the label. The transferred wax layer is typically treated using a post-flaming or post-heating technique to improve the clarity of the printed/ink design under the wax layer and to enhance the protective attributes of the wax layer.

Several drawbacks to the traditional heat-transfer label assembly are well known in the industry. For instance, typical heat-transfer label assemblies involving a wax release layer result in a halo effect or a degree of haziness that is observable over the transferred label when applied to clear materials or articles. The haziness or halo effect is caused by the presence of the wax coating around the outer borders of the transferred ink design layer. Haziness due to the wax layer may also appear inside the borders of the transferred label where no ink design appears, or in the open-copy areas of the label. This haziness or halo effect seriously detracts from the clean appearance of the labeled article and the optical clarity of the ink design itself.

Similarly, when typical heat-transfer labels of the type described are applied to dark-colored containers, the outer wax layer of the label often appears as a whitish coating on the container making the label appear hazy and difficult to read.

Furthermore, wax builds up on the transfer equipment, causing periodic stoppage and production delays needed for maintenance and cleaning.

To overcome the deficiencies of the wax outer layer, considerable effort has been made to replace or obviate the need for a wax release layer. For instance, one such approach was taught in U.S. Pat. No. 4,935,300. The heat-transfer label assembly described therein was particularly suited to use on plastic surfaces and containers, and comprised a paper carrier web overcoated with a layer of thermoplastic polyethylene. A protective lacquer layer comprising a polyester resin and a nondrying oil is printed on the polyethylene layer. An ink design layer is then printed onto the protective lacquer layer, which is then overcoated with a heat-activatable adhesive layer comprising a thermoplastic polyamide adhesive. While the label assembly significantly reduced the wax-related effects of more traditional label assemblies, it was found to lack adequate release characteristics and actually became adhesive when subjected to temperatures typically present during the heat-transfer labeling process. This label assembly is very costly to produce.

Accordingly, another type of heat-transfer label assembly was developed to improve the release characteristics by using a thin layer, or skim coat, of wax interposed between the polyethylene release layer and the protective lacquer layer. Typically the thickness of the skim coat was about 0.1 to 0.4 lbs. per 3,000 sq. ft. of the polyethylene release layer. In addition to improving the release characteristics of the label assembly, the wax skim coat enabled the label to be stretched non-uniformly, if desired, for application to articles with surfaces varying in elevation, for instance.

An example of the skim-coated label assembly is disclosed in U.S. Pat. No. 5,800,656. According to one embodiment, the label assembly taught therein is designed for use with silane-treated glass containers that are subjected to pasteurization conditions. The assembly includes a sheet of paper overcoated with a release layer of polyethylene serving as a support layer. The transfer layer included a phenoxy resin protective lacquer layer, an organic solvent-soluble polyester resin ink layer over the protective lacquer layer, and a water-dispersible acrylic adhesive resin layer over the ink and protective lacquer layers and onto a surrounding portion of the skim coat.

Examples of other wax skim-coat label assemblies are taught in U.S. Pat. Nos. 6,096,408; 6,033,763; 6,083,620 and 6,099,944.

Manufacturers have attempted other ways to overcome the problems with conventional heat-transfer label assemblies discussed above. For instance, many label assemblies include, in addition to the layers described above, an adhesive layer deposited over the ink design to facilitate adhesion of the label onto the receiving article. An example of such a label assembly is taught in U.S. Pat. No. 4,548,857. Other examples are described in U.S. Pat. Nos. 5,766,731; 5,824,176; and 6,042,931.

Additionally, many heat-transfer label assemblies include a protective lacquer layer between the wax release layer and the ink layer, as described above and also disclosed in U.S. Pat. Nos. 4,426,422; 5,800,656; 5,908,694; 5,932,319; 5,927,481; 6,033,763; 6,068,886, inventors Geurtsen et al., issued May 30, 2000; U.S. Pat. No. 6,344,269, inventors Makar et al., issued Feb. 5, 2002.

U.S. Pat. No. 6,537,651, discloses in one embodiment a paper carrier overcoated with a layer of polyethylene, which is then skim-coated with a thin layer of wax. One or more heat-transfer labels are printed onto the skim coat and spaced apart from one another. Each label itself comprises a protective lacquer layer and a heat-activatable adhesive layer printed over the ink design, any exposed areas of the protective lacquer layer and a surrounding area of the skim coat. The periphery of the skim coat extends beyond the label and is, therefore, uncovered by the label. A mask is deposited over the uncovered areas of the skim coat. The mask adheres to the polyethylene layer during label-transfer and prevents transfer onto the receiving article of the previously uncovered areas of the skim coat together with the label.

U.S. Pat. No. 6,423,406, teaches a heat-transfer label that includes a non-wax, non-silicone release layer for use in decorating an article without leaving a visually discernible release residue on the article. In a preferred embodiment, the label includes a transfer portion comprising a protective lacquer layer, an ink design layer over the protective lacquer layer, and a heat-activatable adhesive layer over the ink design and protective lacquer layers, with the adhesive layer extending beyond the peripheries of the ink design and the protective lacquer layers. The support portion of the label assembly includes a carrier comprising polyester film with a non-wax, non-silicone release layer position over the carrier and in direct contact with the protective lacquer layer and the periphery of the adhesive layer.

The present invention improves upon the more conventional wax heat-transfer label assemblies discussed above and significantly reduces the costs associated with these traditional label assemblies. For instance, the present invention eliminates the need for polyethylene or similar hold-out layers. The present invention overcomes the disadvantages of using a wax coating as part of the transfer portion of the label assembly, and improves upon the appearance of the label by diminishing the halo effects of the transferred wax portion. Moreover, the present invention retains the advantages of using a skim-coat wax layer, including the ability to stretch the label assembly and apply it to non-uniform surfaces, while enhancing cost-efficiencies and the environmental aspects of the manufacturing process through the use of electron-beam curing. The present invention also provides a distinctly improved smooth surface for the ink design portion of the label assembly.

### SUMMARY OF THE INVENTION

The present invention relates to a heat transfer label with an electron beam cured surface, and to a method for producing the same. It is an object of the present invention to comprise a heat-transfer label assembly that comprises a support portion that has an electron-beam cured layer, in addition to a transfer portion with a skim-coat of wax or other release material. The support portion of the present invention comprises a carrier, the carrier preferably being a paper substrate. It is an object of the present invention for the paper substrate to be coated with a varnish or other material that is cured by the use of electron-beam radiation. The transfer portion is positioned over the support portion for transfer of the transfer portion to an article upon the application of heat to the support portion, while the transfer portion is placed in contact with the article. It is an object of the present invention for the transfer portion to comprise a skim coat layer of wax or similar release material, and an ink design layer over the skim coat.

The present invention further relates to a heat transfer label assembly comprising: a support portion of paper coated on one side with clay material. It is an object of the present invention to coat or apply by any known means a layer of varnish or other material on top of the clay-coated side of the paper substrate and to cure such varnish or coated material using electron-beam radiation. The paper substrate with the EB-cured surface comprises the support portion of the label assembly. It is an object of the present invention to lay on top of the support portion a skim-coat of wax or other release coating and then print on top of the skim coat layer. The wax and printed layer comprises the transfer portion of the label assembly.

The present invention also relates to a method of making the heat-transfer label assembly comprising: coating or applying to a clay-coated sheet of paper a layer of varnish or other material that is cured by electron beam radiation; passing the EB-cured paper substrate through a press or other printing equipment whereby a skim coat of wax is applied prior to application of an ink/printed design; thereby forming a support portion and transfer portion of the heat-transfer label assembly.

The present invention relates to a heat transfer label assembly comprising: a first layer comprising paper, a second layer comprising a varnish or other coating, a third layer comprising a layer of emulsion wax or similar release coating or material; and a fourth layer comprising a printed ink design layer. All four layers are bonded together to form a transfer label assembly.

It is an object of the present invention for the paper layer to comprise a support portion of the label assembly. It s an object of the present invention for the paper layer to comprise a sheet of paper with a clay coating on one side and a basis weight of about 20 to 40 lbs. per 3,000 sq. ft. It is an object of the present invention for the paper layer to comprise a sheet of paper with a clay coating on one side and a basis weight of about 35 lbs. per 3,000 sq. ft. It is an object of the present invention for the varnish or other coating to be curable by electron beam radiation.

It is an object of the present invention for the electron-beam curable varnish or other coating to comprise a portion of the support portion of the label assembly. It is an object of the present invention for the varnish or other coating to comprise a layer in a thickness of approximately 0.5 to 5 lbs. per 3,000 sq. ft. It is an object of the present invention for the emulsion wax or other release material to comprise a portion of the transfer portion of the label assembly. It is an object of the present invention for the emulsion wax or other release material to comprise a layer of emulsion wax or similar release material in a thickness of about 0.5-5 lbs. per 3,000 sq. ft.

It is an object of the present invention for the emulsion wax or other release material to comprise a layer of emulsion wax or similar release material in a thickness of about 0.75 lbs. per 3,000 sq. ft. It is an object of the present invention for the ink/printed design layer to comprise a portion of the transfer portion of the label assembly. It is an object of the present invention for the first, second, third, and fourth layers to be bonded together to form a transfer label assembly with both support and transfer portions.

It is an object of the present invention for the support portion to be positioned for transfer of the transfer portion to an article upon application of heat to the support portion, while the transfer portion is placed in contact with the article.

### BRIEF DESCRIPTION OF THE DRAWING

FIG. 1 is a cross-sectional view of the heat-transfer label assembly of the present invention.

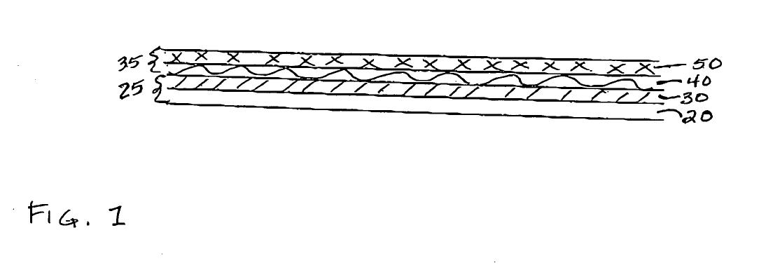

### DETAILED DESCRIPTION OF THE INVENTION

The present invention comprises a heat-transfer label assembly 10 comprising: a support portion 25 of the label assembly and a transfer portion of the label assembly 35. The support portion 25 of the label assembly comprises a sheet of paper with clay coating on one side 20, with the paper having a basis weight of 20 to 40 lbs. per 3,000 sq. ft., preferably having a basis weight of 35 lbs. per 3,000 sq. ft. The clay-coated sheet is then coated with a layer 30 of EB-curable varnish or other material in a thickness of approximately 0.5 to 5 lbs. per 3,000 sq. ft., preferably 1.5 lbs. per 3,000 sq. ft.

The transfer portion 35 of the label assembly comprises a thin layer 40 of emulsion wax or similar release material in a thickness of about 0.5-5 lbs. per 3,000 sq. ft., preferably about 0.75 lbs. per 3,000 sq. ft. An ink/printed design layer 50 covers the wax layer of the transfer portion 35 of the label assembly.

1. A heat transfer label assembly comprising:
a first layer comprising paper;
a second layer comprising a varnish or other coating;
a third layer comprising a layer of emulsion wax or similar release coating or material; and
a fourth layer comprising a printed ink design layer;
wherein all four layer are bonded together to form a transfer label assembly.

2. The heat transfer label assembly of claim 1 wherein said paper layer comprises a support portion of said label assembly.

3. The heat transfer label assembly of claim 1 wherein said paper layer comprises a sheet of paper with a clay coating on one side and a basis weight of about 20 to 40 lbs. per 3,000 sq. ft.

4. The heat transfer label assembly of claim 1 wherein said paper layer comprises a sheet of paper with a clay coating on one side and a basis weight of about 35 lbs. per 3,000 sq. ft.

5. The heat transfer label assembly of claim 1 wherein said varnish or other coating is curable by electron beam radiation.

6. The heat transfer label assembly of claim 4 wherein said electron-beam curable varnish or other coating comprises a portion of the support portion of the label assembly.

7. The heat transfer label assembly of claim 1 wherein said varnish or other coating comprises a layer in a thickness of approximately 0.5 to 5 lbs. per 3,000 sq. ft.

8. The heat transfer label assembly of claim 1 wherein said emulsion wax or other release material comprises a portion of said transfer portion of said label assembly.

9. The heat transfer label assembly of claim 1 wherein said emulsion wax or other release material comprises a layer of emulsion wax or similar release material in a thickness of about 0.5-5 lbs. per 3,000 sq. ft.

10. The heat transfer label assembly of claim 1 wherein said emulsion wax or other release material comprises a layer of emulsion wax or similar release material in a thickness of about 0.75 lbs. per 3,000 sq. ft.

11. The heat transfer label assembly of claim 1 wherein said ink/printed design layer comprises a portion of said transfer portion of said label assembly.

12. The heat transfer label assembly of claim 1 wherein said first, second, third, and fourth layers are bonded together to form a transfer label assembly with both support and transfer portions.

13. A process for making a heat transfer label assembly comprising:
coating or otherwise applying to a clay-coated sheet of paper a layer of varnish or other material that is cured by electron beam radiation;
conveying said EB-cured paper substrate through a press or other printing equipment whereby a skim coat of emulsion wax or similar release material is applied prior to application of an ink/printed design;
forming a support portion and transfer portion of said heat transfer label assembly.

14. The heat transfer label assembly of claim 1 wherein said support portion is positioned for transfer of said transfer portion to an article upon application of heat to said support portion, while said transfer portion is placed in contact with said article.
